(19) United States
(12) Patent Application Publication
(10) Pub. No.: US 2021/0334765 A1
(43) Pub. Date: Oct. 28, 2021

(54) SERVICE KIOSK DEVICE MAINTENANCE

(71) Applicant: Hewlett-Packard Development Company, L.P., Spring, TX (US)

(72) Inventors: Kyle J. Nottingham, Boise, ID (US); Matthew Frederickson, Boise, ID (US); Gerold K. Shelton, Boise, ID (US)

(21) Appl. No.: 16/481,472

(22) PCT Filed: Apr. 30, 2018
(86) PCT No.: PCT/US2018/030282

§ 371 Date: Jul. 28, 2019

(51) Int. Cl. G06Q 10/00; G07C 9/33; G07C 9/29

(52) U.S. Cl. CPC G06Q 10/20; G07C 9/29; G07C 9/33

(57) ABSTRACT

Examples associated with service kiosk device maintenance are described. One example method includes receiving at a service kiosk, authentication data associated with a user, and data associated with a first device currently assigned to the user. The data associated with the first device includes a maintenance task to perform on the first device. A credential from the user that matches the authentication information is received at a physical interface of the service kiosk. The user is granted access to a first compartment of the service kiosk. The first compartment includes a power adaptor and a data adaptor. Upon detecting the first device has been stored in the first compartment and attached to power adaptor and the data adaptor, the maintenance task is performed on the first device.

### BACKGROUND

Computing devices today have become a fundamental part of the way we live and work, as well as smaller and more mobile. Individuals, for example, use computers and mobile devices for entertainment, communication, shopping, and so forth. Further, businesses often provide computers for their employees so that the employees can efficiently carry out their duties across a wide variety of functions. While some businesses take on ownership and maintenance of devices provided to their users, other companies may opt to offload certain information technology costs using a variety of techniques. For example, some companies may rely on a device-as-a-service (DAAS) offering. A DAAS offering may involve periodic payments to a device provider in exchange for user devices and service guarantees for the hardware, software, and so forth, of the devices.

### BRIEF DESCRIPTION OF THE DRAWINGS

The present application may be more fully appreciated in connection with the following detailed description taken in conjunction with the accompanying drawings.

FIG. 1 illustrates an example service kiosk associated with service kiosk device maintenance.

FIG. 2 illustrates a flowchart of example operations associated with service kiosk device maintenance.

FIG. 3 illustrates another flowchart of example operations associated with service kiosk device maintenance.

FIG. 4 illustrates another example service kiosk associated with service kiosk device maintenance.

FIG. 5 illustrates another flowchart of example operations associated with service kiosk device maintenance.

FIG. 6 illustrates an example computing device in which example systems, and methods, and equivalents, may operate.

### DETAILED DESCRIPTION

Examples associated with receptacle isolation are described. As will be more fully described herein, a service kiosk is an apparatus that is meant to store a set of devices for supporting a device-as-a-service model. The service kiosk includes a set of compartments each fitted with connectors to provide a connection between a device stored within the compartment and various control modules embedded in the service kiosk. The service kiosk may be physically installed in a location accessible to employees of a company relying on a device-as-a-service model to provide electronic devices to its employees. When service events associated with devices occur, the employees may visit the kiosk to have their device repaired by the kiosk and/or replaced by backup devices stored in the kiosk. This may increase the uptime of devices assigned to the employees. The backup devices may also reduce support costs associated with sending out technicians to provide support as a device failure can be at least temporarily mitigated by replacing the failed device with a new device in the kiosk, until eventually, a technician can be sent out to efficiently service or replace many devices stored in the kiosk in a single visit.

This disclosure covers the process by which a service kiosk is able to perform maintenance on devices. The service kiosk may receive data associated with a device including a maintenance task to perform on the device. When a user assigned the device authenticates themselves to the service kiosk, the service kiosk may provide the user access to a compartment having power and data connectors for the device. The data connector may allow the service kiosk to configure the device directly to resolve the technical issue. In cases where configuring the device will take an extended period of time, or where resolving the technical issue involves in person maintenance by a technician, the service kiosk may provision an alternative device for the user.

It is appreciated that, in the following description, numerous specific details are set forth to provide a thorough understanding of the examples. However, it is appreciated that the examples may be practiced without limitation to these specific details. In other instances, methods and structures may not be described in detail to avoid unnecessarily obscuring the description of the examples. Also, the examples may be used in combination with each other.

“Module”, as used herein, includes but is not limited to hardware, firmware, software stored on a computer-readable medium or in execution on a machine, and/or combinations of each to perform a function(s) or an action(s), and/or to cause a function or action from another module, method, and/or system. A module may include a software controlled microprocessor, a discrete module, an analog circuit, a digital circuit, a programmed module device, a memory device containing instructions, and so on. Modules may include gates, combinations of gates, or other circuit components. Where multiple logical modules are described, it may be possible to incorporate the multiple logical modules into one physical module. Similarly, where a single logical module is described, it may be possible to distribute that single logical module between multiple physical modules.

As used herein a service kiosk is intended to broadly describe a category of apparatuses used to securely store electronic devices in a manner that allows the devices to be configured while stored in the service kiosk. The service kiosk may have one or more compartments having data and/or power connectors. Devices that are attached to the data connectors may be configured either directly by the service kiosk or remotely by a remote service. Depending on where the devices are in their life cycle, the configuration may include setting up a device for a new user, modifying the device on behalf of a current user (e.g., reconfiguring the device, repairing the device), deprovisioning a device, and so forth. The service kiosk may also include an interface for communicating with and/or authenticating users. Once authenticated, the service kiosk may grant the user access to devices and or compartments to allow the user to perform a task related to a device assigned to the user. The task may involve obtaining a device from the kiosk, storing a device in the kiosk, and so forth. In various examples, the service kiosk may resemble, for example, a vending machine, a set of lockers, a chest of drawers, and so forth. Various structural components of a service kiosk may be made from wood, metal, plastic, or other suitable materials. The service kiosk may include structural elements such as legs, supports, wall fasteners, and so forth.

Consequently, the service kiosk may facilitate fulfilling service guarantees of a device-as-a-service (DAAS) offering. In a DAAS offering, a user or business may periodically pay a device provider for a device and a promise to service the device in the event the device fails. The service guarantee may include a variety of terms and in various examples may cover firmware, software, hardware, device data, user data, periodic lifecycle upgrades, and so forth. In this example, ownership of the device may remain with the device provider. In the event of a failure of the device or some other technical issue related to the device, a service kiosk stationed in a location accessible to the user may allow the device provider to more easily provide technical support for the device, up to and including replacing the device with a working device. For businesses that are relying on several devices at any given time, it may be cost effective for the business to have an on-site service kiosk to be able to quickly provision a new device for a new user, deprovision a device when that device's user leaves the business, and so forth, in addition to the technical support features that may be facilitated by the service kiosk itself. Eventually, when it is determined that the state of the devices in the service kiosk make it likely the service kiosk will begin failing to fulfil the service guarantee to the business (e.g., because the service kiosk is full, empty, has a number of devices in need of repair, or a combination of factors) a technician may be called to service the kiosk and/or devices stored within. This may be less expensive to the business and/or the device provider than having a technician on site, or having a technician called to service each malfunctioning device.

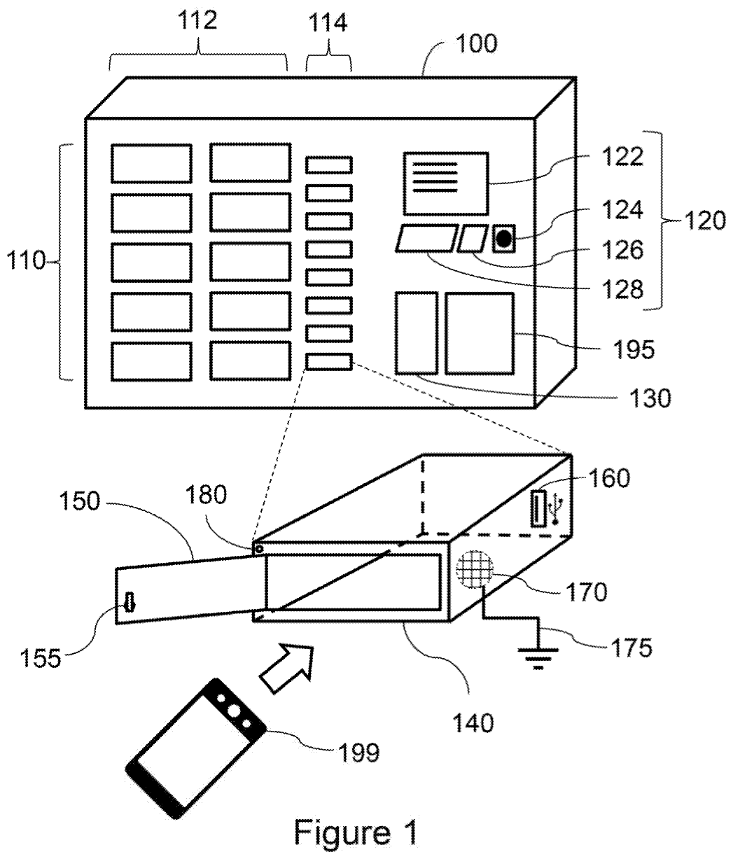

FIG. 1 illustrates an example service kiosk 100 associated with receptacle isolation. Service kiosk 100 includes a set of receptacles 110. While 18 receptacles are shown, in other examples, service kiosk 100 may include a greater or lesser number of receptacles. The receptacles 110 may be adapted for storing electronic devices 199. Different receptacles may be adapted to store different types of electronic devices 199. Here for example, receptacles 112 may be adapted to store a first type of device (e.g., laptops), and receptacles 114 may be adapted to store a second type of device (e.g., cell phones). In other examples, receptacles may be configured to store different types, models, and/or brands of laptops, phones, tablets, or other device types. Receptacles 110 may be adapted to store different types of devices based on a variety of attributes. For example, receptacles 110 for storing phones may be smaller than receptacles 110 for storing laptops.

One receptacle 140 is illustrated in additional detail to further illustrate features of receptacles 110. In this example, receptacle 140 is adapted for storing cellular phones 199. This may affect the size of receptacle 140, connectors 160 installed in receptacle 140, and so forth. Here, receptacle 140 is shown as having a universal serial bus (USB) connector 160. USB connector 160 may provide power to device 199 as well a data connection between device 199 and other components of service kiosk 100. For laptops, receptacles 110 may use a different configuration of connectors 160 for providing power and/or data to a device 199. For example, a regional power adaptor may be used for providing power to devices. The data connection for a laptop may be provided using, for example, an ethernet port, a universal serial bus port, or other types of ports.

It is also worth observing that in other examples, connector 160 may take different physical forms. Here, connector 160 is illustrated as a USB port in the rear wall of receptacle 140. This may mean that to connect device 199 to connector 160, an appropriate cable would also need to be provided. In other examples, connectors 160 may be cables or retractable cables of the appropriate type for connecting to a device type for which receptacle 140 is configured, a docking port of the appropriate type for connecting to a device type for which receptacle 140 is configured, a wireless communication transmitter (e.g., WIFI, Bluetooth) and so forth. The different connector types may have different tradeoffs. For example, a USB port as illustrated may ensure that a device appropriate cable is provided to a user who obtains a device from receptacle 140, but would also mean that a user inserting a device 199 would have to bring or be provided such a cable. Alternatively, a connector that involves an installed cable or docking port may ensure that a person inserting a device into receptacle 140 would be able to insert the device without providing an additional cable, but would mean that a user retrieving a device from receptacle 140 would have to be provided an appropriate cable through an alternative method.

Receptacle 140 also includes a locking mechanism 155. In this example, locking mechanism 155 is illustrated as being attached to a door 150 of receptacle 140. However, locking mechanism 155 may take a variety of forms and its form may depend on the form by which door 150 is designed to give access to users. Here for example, door 150 is illustrated as opening outwards, though in other examples, a sliding, rotating, or retracting door may be appropriate. Locking mechanism 155 may be controllable by other components of service kiosk 100 to grant and restrict access to receptacle 140. These other components and the situations in which access to receptacle 140 may be controlled are more fully discussed below. In some examples, it may also be desirable for locking mechanism 155 to be controllable via a physical mechanism (e.g., a service key). This may allow receptacle 140 to be serviced by a technician to, for example, modify the contents of receptacle 140, repair a component of receptacle 140, and so forth, even when service kiosk 100 is unpowered.

In this example, receptacle 140 is illustrated as incorporating a digital isolator 170. Here, digital isolator 170 is illustrated as a faraday cage 170 that is built into the structure of receptacle 140. Faraday cage 170 may prevent wireless electronic signals from being transmitted by device 199 to devices external to receptacle 140, as well as preventing device 199 from receiving wireless signals from devices external to receptacle 140. In this example, faraday cage 140 is illustrated as being grounded 175, though in other examples, the ground may be excluded. Other digital isolation techniques may also be employed. For example, digital isolation may also be achieved via the port 160 providing a data connection between device 199 and other components of service kiosk 100. By way of illustration service kiosk 100 may implement individualized networks to prevent direct transmission of wired signals between devices in members of the set of receptacles 110. This may also prevent devices 199 from detecting whether other devices are connected to service kiosk 100. Digital isolation may also include signal isolation to ensure secure communication between devices in the receptacles 110 and other components of service kiosk 100. In some examples, digital isolation may also incorporate power isolation.

Service kiosk 100 also includes an interface 120. Interface 120 may include several components. Here interface 120 includes a display 122, a keyboard 128, a keypad 126, and a radio frequency identification (RFID) scanner 124. Interface 120 may use these components to facilitate communicating with user interacting with service kiosk 100. Interface 120 may also include additional components including for example, cameras, touch input devices, external device connectors (e.g., to provide power and/or data to devices not in receptacles 110), and so forth. Interface 120 may also make use of lights 180 associated with individual receptacles 110. These lights 180 may allow the interface to direct a user to a specific receptacle 110 of service kiosk 100. For example, when service kiosk 100 seeks to direct a user to a specific receptacle 110, service kiosk 100 may control a light on that receptacle to turn on, blink, and so forth.

Service kiosk 100 may also include a variety of modules 130 for performing various functions associated with service kiosk 100 and/or configuring devices 199 stored in compartments 110 of service kiosk 100. Modules 130 may be, for example, performed by a processor of a computer embedded in service kiosk 130. In other examples, modules 130 may act as a communication pass through for communications between a remote information technology module (e.g., a device-as-a-service operation) and devices 199 stored in compartments 110 of service kiosk 100.

In various examples, the modules 130 may interact with a user via interface 120, with devices 199 in compartments 110, with other modules 130, and with remote servers and/or devices. For example, modules 130 may include an authentication module. The authentication module may receive a credential from a user and authenticate the credential based on authentication data associated with the user. The authentication data may have been received from a remote information technology module. When the user is successfully authenticated, the authentication module or another module 130 of service kiosk 100 may grant the user access to one or more receptacles 110 of service kiosk 100. The user may provide the credential via user interface 120. The credential may be, for example, a username and password pair that identifies the user that the user inputs via keyboard 128. In another example, the credential may be an RFID signal the user provides via RFID scanner 124. In another example, the user may authenticate themselves by attaching the mobile device 199 to a data connector of service kiosk 100. Multi-factor authentication may also be appropriate involving a combination of the above and/or other authentication techniques.

In various examples, service kiosk 100 may be selective about granting user access to receptacles 110. How service kiosk 100 determines which receptacles 110 to which a user is granted access may depend on what function service kiosk 100 is performing for the user. In various examples, the user may be picking up a device from service kiosk 100, storing a device in service kiosk 100, having a device repaired or configured by service kiosk 100, diagnosing a technical issue with a device with the help of service kiosk 100, and so forth. In these examples, service kiosk 100 may grant such a user access only to receptacles associated with the task being performed by service kiosk 100. The user may be granted access to these receptacles 110 by service kiosk 100 controlling locking mechanisms 155 on the respective receptacles 110. In cases where the user is a technician responsible for servicing service kiosk 100, the user may be granted access to specific receptacles, or in some cases general access to all receptacles 110. This may allow the technician to adjust the contents of the receptacles and/or perform physical maintenance on devices stored within service kiosk 100 or on service kiosk 100 itself.

Service kiosk 100 may also include a variety of other components 195. For example, component 195 may be a compartment storing additional supplies that support the purpose of service kiosk 100. By way of illustration, component 195 may store spare parts, extra data and/or power cables, and so forth that may be used by users interacting with service kiosk 100. In other examples, component 195 may also store, for example, packaging and mailing supplies for shipping devices 199 for service. Other potential components 195 may also be contemplated,

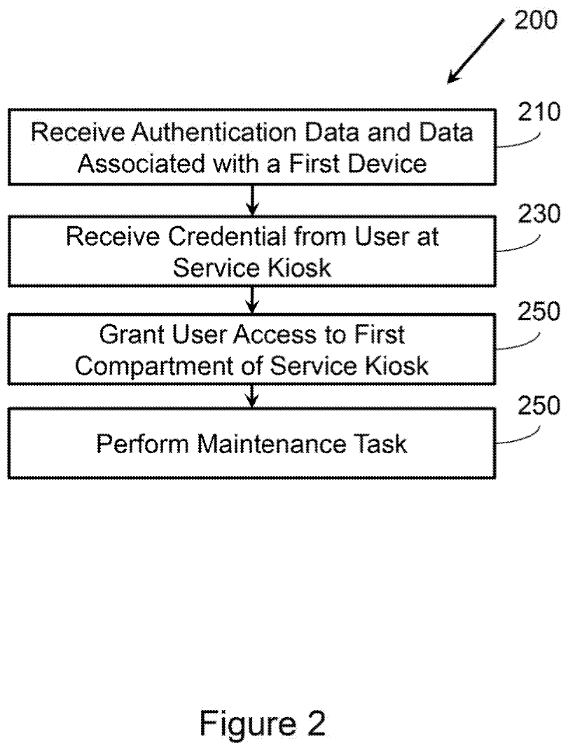

FIG. 2 illustrates an example method 200. Method 200 may be embodied on a non-transitory processor-readable medium storing processor-executable instructions. The instructions, when executed by a processor, may cause the processor to perform method 200. In other examples, method 200 may exist within logic gates and/or RAM of an application specific integrated circuit (ASIC).

Method 200 may perform various tasks associated with service kiosk device maintenance. Method 200 includes receiving authentication data and data associated with a first device at 210. This data may be received at a service kiosk. The authentication data may be associated with a user, and the first device may be a device currently assigned to the user. The data associated with the first device may identify a maintenance task to perform on the first device.

Method 200 also includes receiving a credential from the user at 230. The credential may be received a physical interface of the service kiosk. The physical interface may include, for example, a display, a keypad, a keyboard, a radio frequency identification (RFID) scanner, and so forth. The credential may be, for example, a password, a biometric, a radio frequency identifier, a multifactor credential, and so forth. In other examples, the credential may be received from the user, after which the service kiosk verifies the credential with an external source. In this example, the authentication data received at action 210 may include data that controls the service kiosk to grant the user to access features of the service kiosk.

Method 200 also includes granting the user access to a first compartment of the service kiosk at 260. The user may be granted access when the credential provided by the user at action 230 matches the authentication information received at action 210. The first compartment may include a first power adapter and a first data adaptor. It should be appreciated that the first power adapter and the first data adapter may be the same adapter as certain types of devices (e.g., those using USB type C) are capable of using a single adapter to provide both power and data connections. The compartment to which the user is granted access may be based on a device type of the first device. By way of illustration if the first device is a laptop, the compartment to which the user is granted access may have different attributes from a compartment configured for receiving a cellular phone.

Method 200 also includes performing the maintenance task at 260. The maintenance task may be performed upon detecting that the first device has been stored in the first compartment and attached to the first data adaptor and the first power adaptor. The maintenance task may include, for example, updating a firmware of the first device, updating an operating system of the first device, installing an application on the first device, updating an application on the first device, removing an application from the first device, updating settings on the first device, updating access privileges associated with the user, restoring the first device to a prior valid state, imaging the first device according to a saved backup image file, removing malicious data from the first device, and so forth. In some examples, the maintenance task may include notifying a technician that the first device has been stored in the service kiosk. This may allow the technician to perform a physical maintenance task on the first device. A physical maintenance task may include, for example, physically replacing or repairing a component of the first device, performing an in-person diagnosis of an issue being experienced by the first device, and so forth. When a technician is called to service the first device, the technician may be granted access to the first compartment after the technician authenticates a credential with the service kiosk.

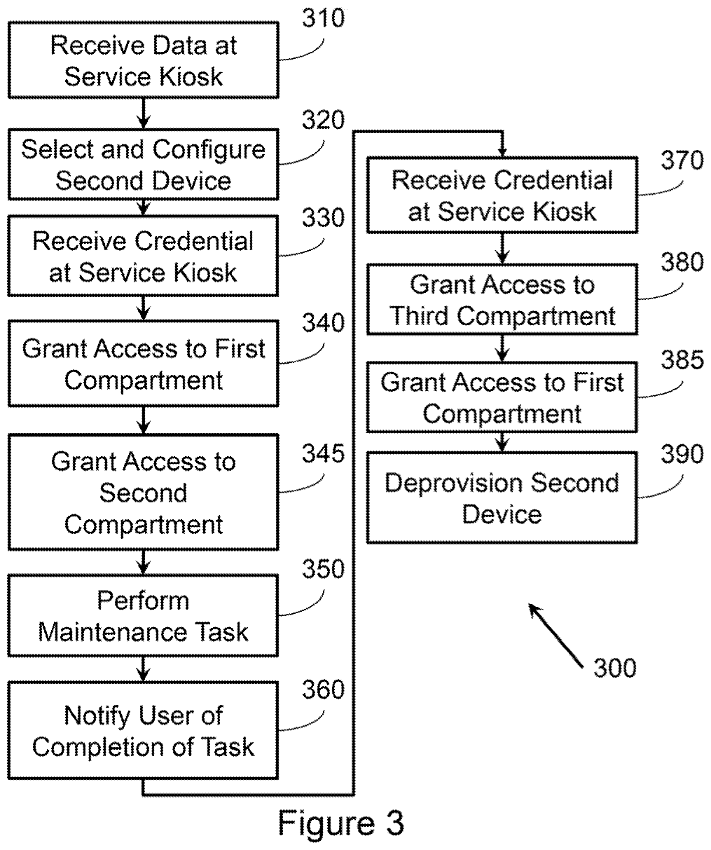

FIG. 3 illustrates a method 300 associated with service kiosk device maintenance. Method 300 includes several actions similar to those described above with reference to method 200. For example, method 300 includes receiving data at a service kiosk at 310, receiving a credential from a user at the service kiosk at 330, granting access to the first compartment at 340, and performing a maintenance task at 350.

Method 300 also includes selecting a second device from a second compartment of the service kiosk at 320, and configuring the second device. The second compartment may include a second power adaptor and a second data adaptor. Thus, the second device may be configured via the second data adaptor. Configuring the second device may be based on provisioning data associated with the user. The provisioning data may include, for example, applications to install on the second device, credentials associated with the user, settings to apply to the second device, data to load to the second device, and so forth. When the second device is provisioned for the user, the user may be granted access to the second compartment at 345.

Method 300 also includes notifying the user at 360. The user may be notified that the maintenance task on the first device has been completed and that the first device is ready to be retrieved from the service kiosk. The user may be notified by, for example, sending the user an email, a text message, a phone call, an alert on another device accessible by the user (e.g., the second device), and so forth.

Method 300 also includes receiving the credential from the user at 370. The credential may be received at the physical interface of the service kiosk. Again, when this credential matches the authentication information, method 300 may grant access to one or more compartments of the service kiosk, such as third compartment at 380, and first compartment at 385. Giving the user access to the first compartment may allow the user to retrieve the first device from the service kiosk once the maintenance task on the first device has been completed. Granting the user access to the third compartment may allow the user to return the second device to the service kiosk. The third compartment may also include a third power adapter and a third data adaptor, and upon detecting the second device has been stored in the third compartment and attached to the third power adaptor and third data adaptor, method 300 includes deprovisioning the second device at 390. It should be appreciated that one or more of the first compartment, the second compartment, and the third compartment may be the same compartment. Whether there is overlap between the compartments may depend on, for example, whether the first device and second device use the same connector types, the contents of the compartments, and so forth.

To illustrate, the service kiosk, upon determining the user should be provided a temporary replacement device, may select a compartment with an appropriate device and provision the device for the user. The user may retrieve the temporary device, from that compartment, and store the device for repair in that compartment. When the maintenance task has been completed, the user may again swap the devices in the same compartment. In other examples, the replacement device and the device being repaired may have different attributes, and the service kiosk may grant the user access to different compartments to the user to access the different devices. Additionally, during the time while maintenance is being performed, the compartment in which the replacement device is stored may be taken by a different device, causing service kiosk to have the user return the replacement device to a different compartment then the compartment from which the replacement device was originally retrieved. There may be other scenarios that cause the service kiosk to select different compartments for devices. Additionally, the service kiosk may grant access to a compartment containing the temporary device before being asked to store the device repair in the same or a different compartment, or in other orderings.

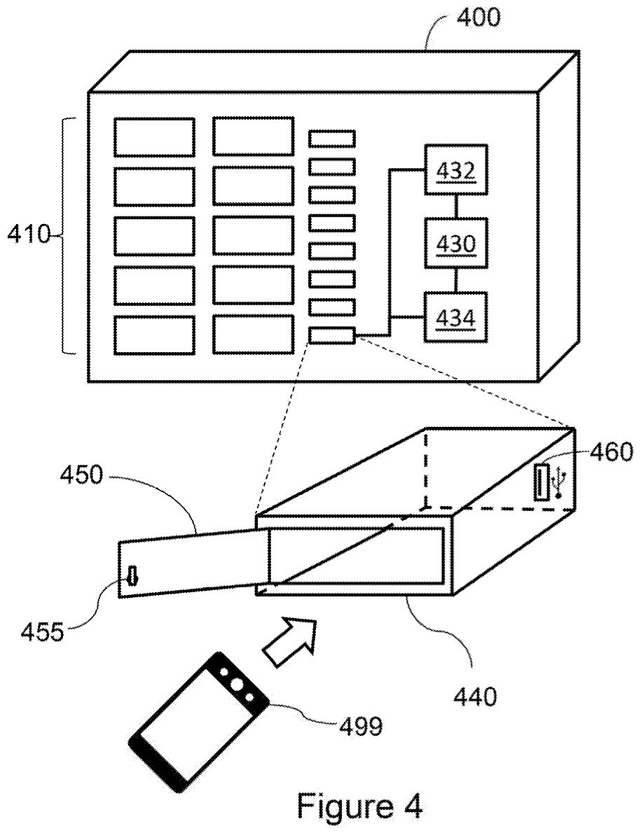

FIG. 4 illustrates an example service kiosk 400 associated with service kiosk provisioning. Service kiosk 400 includes a set of receptacles 410. An example receptacle 440 is illustrated in additional detail. Each member of the set of receptacles 410 may include an adaptor 460. Adaptor 460 may provide power to an electronic device 499, a data connection between electronic device 499 and components of service kiosk 400, and so forth. Members of the set of receptacles 410 may also include a locking mechanism 455 to secure the contents of the receptacles 410 (e.g., electronic device 499). In this example, locking mechanism 455 is attached to a door 450 of example receptacle 440. Here the locking mechanism may be able to rotate in a manner that prevents door 455 from opening.

Service kiosk 400 also includes a data receipt module 430. Data receipt module 430 may receive data associated with a user, and data associated with a first device 499 currently assigned to the user. The data associated with the user may include authentication information associated with the user. The data associated with first device 499 may include a maintenance task to perform on the first device.

System 400 also includes an authentication module 432. Authentication module 432 may authenticate the user based on a credential provided by the user and based on the authentication information associated with the user. Authentication module may then control a selected locking mechanism (e.g., locking mechanism 455) on a selected member of the set of receptacles (e.g., receptacle 440) to grant physical access to the user. This may allow the user to insert first device 499 into selected receptacle 440.

System 400 also includes a maintenance module 434. Maintenance module 434 may perform the maintenance task on first device 499. The maintenance task may be performed when maintenance module 434 detects that the user has attached the first device to an adaptor (e.g., adaptor 460) in selected receptacle 440. The maintenance task may include, for example, updating a firmware of first device 499, installing an application on first device 499, removing an application from first device 499, updating settings on first device 499, updating access privileges associated with the user, restoring first device 499 to a prior valid state, imaging first device 499 according to a saved backup image file, removing malicious data from first device 499, and so forth.

In some examples, service kiosk 400 also includes a provisioning module (not shown). The provisioning module may use provisioning data associated with the user to configure a second device. The second device may be stored in a second receptacle from set of receptacles 410. Here, authentication module 432 may also control a second locking mechanism to grant the user access to the second receptacle. This may allow the user to retrieve the second device. Providing the user the second device may be appropriate when, for example, the maintenance task will take a longer than predetermined period of time, when it is appropriate according to a policy to replace first device 499 with a newer device, when the maintenance task is associated with an end of life cycle event of first device 499, and so forth.

In some examples authentication module 432 may also authenticate the user based on the credential after the maintenance task has been completed. Here, authentication module 432 may control selected locking mechanism 455 of selected receptacle 440 to grant physical access to the user to allow the user to retrieve first device 499 from selected receptacle 440.

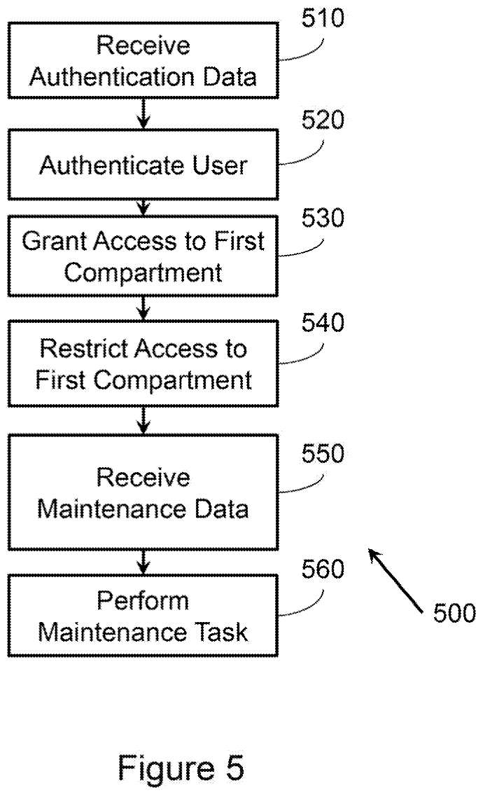

FIG. 5 illustrates an example method 500 associated with service kiosk device maintenance. Method 500 includes receiving authentication data at a service kiosk at 510. Method 500 also includes authenticating the user at a physical interface of the service kiosk. The user may be authenticated based on a credential provided by the user that matches the authentication data received at action 510.

Method 500 also includes granting access to a first compartment of the service kiosk at 530. This may be achieved by controlling a locking mechanism on the first compartment. Granting access to the first compartment may allow the user to connect a first device to an adaptor within the first compartment.

Method 500 also includes restricting access to the first compartment at 540. This may be achieved by controlling the locking mechanism on the first compartment.

Method 500 also includes receiving maintenance data at 560. The maintenance data may describe a maintenance task to perform on the first device. Method 500 also includes performing the maintenance task at 560.

As above, method 500 may also include notifying the user of completion of the maintenance task, authenticating the user a second time, and granting the user access to the first compartment to allow the user to retrieve the first device. Similarly, method 500 may also include provisioning a second device for the user to use while the maintenance task is being performed on the first device.

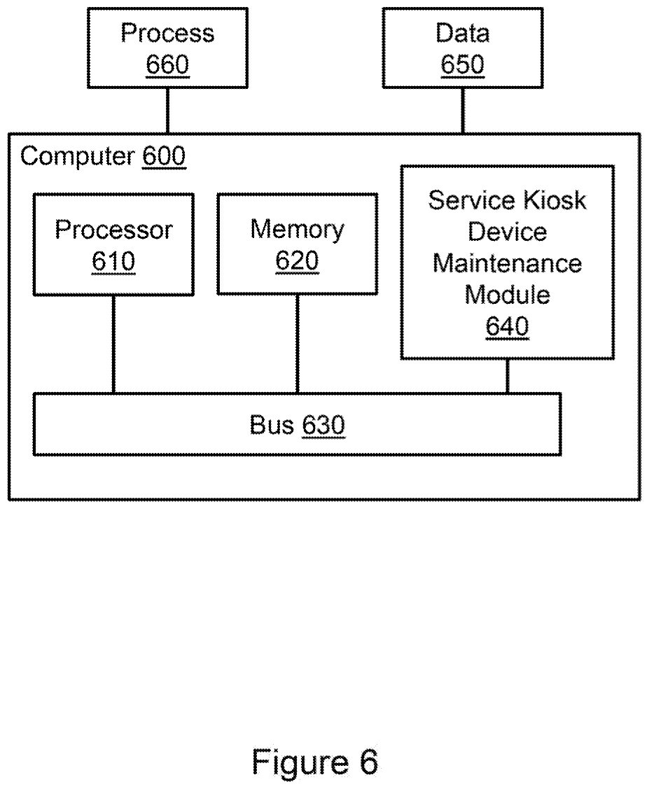

FIG. 6 illustrates an example computing device in which example systems and methods, and equivalents, may operate. The example computing device may be a computer 600 that includes a processor 610 and a memory 620 connected by a bus 630. Computer 600 includes a service kiosk device maintenance module 640. Service kiosk device maintenance module 640 may perform, alone or in combination, various functions described above with reference to the example systems, methods, and so forth. In different examples, service kiosk device maintenance module 640 may be implemented as a non-transitory computer-readable medium storing processor-executable instructions, in hardware, software, firmware, an application specific integrated circuit, and/or combinations thereof.

The instructions may also be presented to computer 600 as data 650 and/or process 660 that are temporarily stored in memory 620 and then executed by processor 610. The processor 610 may be a variety of processors including dual microprocessor and other multi-processor architectures. Memory 620 may include non-volatile memory (e.g., read-only memory, flash memory, memristor) and/or volatile memory (e.g., random access memory). Memory 620 may also be, for example, a magnetic disk drive, a solid state disk drive, a floppy disk drive, a tape drive, a flash memory card, an optical disk, and so on. Thus, memory 620 may store process 660 and/or data 650. Computer 600 may also be associated with other devices including other computers, devices, peripherals, and so forth in numerous configurations (not shown).

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

What is claimed is:

1. A method, comprising:
receiving, at a service kiosk, authentication data associated with a user, and data associated with a first device currently assigned to the user, where the data associated with the first device includes a maintenance task to perform on the first device;
receiving at a physical interface of the service kiosk, a credential from the user;
granting the user access to a first compartment of the service kiosk when the credential matches the authentication information, the first compartment including a first power adapter and a first data adaptor; and
upon detecting that the first device has been stored in the first compartment and attached to the first data adaptor and the first power adaptor, performing the maintenance task on the first device.

2. The method of claim 1, comprising:
receiving at the physical interface of the service kiosk, the credential from the user; and
granting the user access to the first compartment to allow the user to retrieve the first device when the credential matches the authentication information.

3. The method of claim 2, comprising notifying the user that the maintenance task has been completed and that the first device is ready to be retrieved from the service kiosk.

4. The method of claim 1, where the method comprises:
selecting a second device from a second compartment of the service kiosk, the second compartment including a second power adaptor and a second data adaptor;
configuring the second device using the provisioning data via the second data adaptor; and
granting the user access to the second compartment to provide the second device to the user while the maintenance task is being performed.

5. The method of claim 4, comprising granting the user access to a third compartment to allow the user to return the second device to the service kiosk, the third compartment including a third power adaptor and a third data adaptor; and
upon detecting the second device has been stored in the third compartment and attached to the third power adaptor and the third data adaptor, deprovisioning the second device.

6. The method of claim 1, where the maintenance task includes at least one of, updating a firmware of the first device, updating an operating system of the first device, installing an application on the first device, updating an application on the first device, removing an application from the first device, updating settings on the first device, updating access privileges associated with the user, restoring the first device to a prior valid state, imaging the first device according to a saved backup image file, and removing malicious data from the first device.

7. The method of claim 1, where the maintenance task includes notifying a technician that the first device has been stored in the service kiosk to allow the technician to perform a physical maintenance task on the first device.

8. A service kiosk, comprising:
a set of receptacles adapted to store the electronic devices, each receptacle comprising:
an adaptor for providing at least one of power to an electronic device, and a data connection between the electronic device and components of the service kiosk; and
a locking mechanism to secure contents of the receptacle;
a data receipt module to receive a data associated with a user, and a data associated with a first device currently assigned to the user, where the data associated with the user includes authentication information associated with the user, and where the data associated with the first device includes a maintenance task to perform on the first device;
an authentication module to authenticate the user based on a credential provided by the user and based on the authentication information associated with the user, and to control a selected locking mechanism of a selected member of the set of receptacles to grant physical access to the user to allow the user to insert the first device into the selected receptacle; and
a maintenance module to perform the maintenance task on the first device upon detecting that the user has attached the first device to an adaptor in the selected member of the set of receptacles.

9. The service kiosk of claim 8, where the authentication module is further to, after the maintenance task has been completed, authenticate the user based on the credential, and control the selected locking mechanism of the selected member of the set of receptacles to grant physical access to the user to allow the user to retrieve the first device from the selected receptacle.

10. The service kiosk of claim 8, comprising a provisioning module to use provisioning data from the data associated with the user to configure a second device stored in a second receptacle from the set of receptacles, and where the authentication module is further to control a second locking mechanism to grant the user access to the second receptacle to allow the user to retrieve the second device.

11. The service kiosk of claim 8, where the maintenance task includes at least one of updating a firmware of the first device, updating an operating system of the first device, installing an application on the first device, removing an application from the first device, updating settings on the first device, updating access privileges associated with the user, restoring the first device to a prior valid state, imaging the first device according to a saved backup image file, and removing malicious data from the first device.

12. A non-transitory computer-readable medium storing processor executable instructions that, when executed, control a processor to:
receive, at a service kiosk, authentication data associated with user;
authenticate the user at a physical interface of the service kiosk based on a credential provided by the user that matches the authentication information;
control a locking mechanism on a first compartment of the service kiosk to grant access to the user to allow the user to connect a first device to an adaptor within the first compartment;
control the locking mechanism to restrict access to the first compartment upon detecting the first device has been connected to the adaptor;
receiving maintenance data describing a maintenance task to perform on the first device; and
performing the maintenance task on the first device.

13. The non-transitory computer-readable medium of claim 12, where the instructions further control the processor to:
notify the user of completion of the maintenance task;
authenticate the user at the physical interface of the service kiosk based on the credential provided by the user that matches the authentication information;
control the locking mechanism on a first compartment of the service kiosk to grant access to the user to allow the user to retrieve the first device from the first compartment.

14. The non-transitory computer-readable medium of claim 12, where the instructions further control the processor to:
receive provisioning data associated with the user;
select a second device from a second compartment of the service kiosk;
configure the second device using the provisioning data via a second adaptor within the second compartment; and
grant the user access to the second compartment to provide the second device to the user while the maintenance task is being performed on the first device.

15. The non-transitory computer-readable medium of claim 12, where the maintenance task includes notifying a technician that the first device has been stored in the service kiosk, authenticating a credential associated with the technician, and granting the technician access to the first compartment to allow the technician to perform a physical maintenance task on the first device.
